(19) United States
(12) Patent Application Publication
(10) Pub. No.: US 2004/0101325 A1
(43) Pub. Date: May 27, 2004

(54) Apparatus for warming up light source lamp for image input device and control method thereof

(75) Inventor: Won-Suk Choi, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/702,602

(22) Filed: Nov. 7, 2003

(30) Foreign Application Priority Data
Nov. 25, 2002 (KR) 2002-73401

(51) Int. Cl. G03G 15/00; G03G 21/00

(52) U.S. Cl. 399/75; 399/81

(57) ABSTRACT

An apparatus to warm up a light source lamp of an image input device and a method thereof. The light source lamp warming up apparatus includes a scanner module having the light source lamp, the scanner module turning on/off the light source lamp in accordance with a received control signal, an operation panel having a numeral key, function key and a display window, wherein the operation panel is used to input an on/off time or day of the light source lamp, a real time clock (RTC) processing time data such as year, month, date, day, hour, minute, and second, a memory storing the on/off time or day of the light source lamp, and a control unit controlling the memory to store the on/off time or day input through the operation panel, and controlling the scanner module so that the light source lamp is turned on in response to the input of electricity, wherein the control unit determines whether or not the on/off time or day of the light source lamp is preset, and upon determining a lamp-off time according to the time data input through the real time clock, controlling the scanner module to turn off the light source lamp, and controlling the scanner module so that in response to a key input signal being entered through the operation panel with the light source lamp being in an off state, or in response to the determination of a preset lamp-on time, the light source lamp is turned on.

### CROSS-REFERENCE TO RELATED APPLICATIONS

This application claims the benefit of Korean Application No. 2002-73401, filed Nov. 25, 2002, in the Korean Intellectual Property Office, the disclosure of which is incorporated herein by reference.

### BACKGROUND OF THE INVENTION

1. Field of the Invention

The present invention relates to an image input device such as a scanner, and, more particularly, in a device such as a scanner, a copier, or a multifunction machine with the function of a scanner and a copier having an image input device that requires warming up of a light source lamp for a predetermined time period for a saturation of the light source, to an apparatus and method for warming up the light source lamp which is capable of optimizing the warming up time of the light source lamp, thereby preventing a waste of electricity, and extending the lifetime of the light source.

2. Description of the Related Art

Generally, an image input device operates in such a manner that a light is emitted from a light source onto a paper sheet, and the reflected light from the paper sheet is converted into an electric output value through an image reading sensor such as a charge coupled device (CCD) and a contact image sensor (CIS). The electric output value is then stored in a data recording medium, such as a hard disc of a computer.

A scanner is one example of an image input device which reads the content of a document such as a paper sheet or a book. The image input device may also be applied as a part of a multifunction machine having the function of a copier and a fax.

FIG. 1 is a block diagram illustrating a multifunction machine which is capable of reading in an image, printing the read image, and faxing the read image. As shown, the multifunction machine is connected with a personal computer (PC), and includes a flatbed scanner module 13 for reading in an image, a printer 18 for outputting the read image, and a modem 16 for a fax transmission.

A control processing unit (CPU) 11 is provided to control the overall operation of the system, and also to control a system memory 14 in which a program for driving the entire system is embedded. The CPU 11 is connected with an operation panel 17 through a serial communication, to thus exchange data enabling indication of key input and LCD-displayed data. The CPU 11 also controls an image processor 12, which scans image data through the flatbed scanner module 13, and the image data which is processed at the image processor 12.

The modem 16 and a line interface unit (LIU) 16′ control the fax transmission of the processed image data, and perform an enhanced capability port (ECP) interfacing so that the image data can be transmitted to the PC. The printer driver 19 is for controlling the printing of PC data or fax data.

With respect to the image data input from the scanner module 13, the image processor 12 performs functions such as a shading, a gamma collection, a reduction/enlargement conversion, an edge emphasis, and an error diffusion. The flatbed scanner module 13 reads the image data, moving under a glass plate on which the document is placed.

The operation panel 17 is arranged to operate different figure keys and options, and the LCD 17′ is used for providing convenience in operation by notifying an operator about the current status of the system.

An image memory 15, such as an image data processing buffer memory, is provided for the image processing at the image processor 12, and the system memory 14 is formed of a flash memory embedded with overall system programs and a volatile memory, such as a DRAM, for data processing.

The ECP 20 is a module for bi-directional parallel interface with the PC according to IEEE 1284, which is provided for the transmission of scanned data to the PC and the reception of data to be printed from the PC. The printer driver 19 is provided to control the printing operation of an inkjet printing system, such as a print head control, carriage motor phase control, a position control, a printing data control, and a line feed motor control. A real time clock (RTC) 21 is provided for the processing of time data such as second/minute/hour, date, and day of the week with a real-time clock.

In the multifunction machine as described above, the scanner module 13 needs to be provided with a light source lamp for emitting a light onto a document and receiving the light reflected from it. Such a light source lamp is warmed up before being turned on, and two ways of controlling this process are described below.

First, as a scan command is transmitted to the image input device through an application program of the computer connected with the image input device, the light source lamp of the image input device may be turned on, i.e., started to warm up. Second, a predetermined amount of electricity may be constantly supplied to the light source lamp, maintaining the light source lamp in a warm-up state as long as the computer connected to the image input device is powered on.

However, the first way inevitably results in a deteriorated scanning speed, because it takes some time for the light source lamp to initially warm up. By its own characteristics, the light source lamp can reach 100% brightness only when the ambient temperature is approximately 40° C., which occurs after a predetermined time when the light source lamp is turned on.

More specifically, in order to obtain a desired image quality of the scanning, 100% brightness has to be ensured. Accordingly, when the light source lamp is turned on, the scanning is performed after a predetermined period of time in which the light source lamp gradually increases ambient temperature to a predetermined desired temperature and also reaches a predetermined brightness. Such a delay in scanning subsequently deteriorates the scanning speed and the performance of the image input device.

The second way of warming up the lamp also causes problems. That is, because the light source lamp is always in a warm up state, unnecessary power is consumed, while the operator has to endure an eye-disturbing light during operation.

### SUMMARY OF THE INVENTION

It is an aspect of the invention to solve at least the above and/or other problems and disadvantages and to provide at least the advantages described hereinafter.

Another aspect of the present invention is, for a device such as a scanner, a copier or a multifunction machine with the function of scanner and copier having an image input device that requires warming up of the light source lamp for a predetermined time period for a saturation of the light source, to provide an apparatus and method for warming up a light source lamp, which is capable of optimizing the warming up time of the light source lamp, thereby preventing the waste of electricity and extending the lifetime of the light source.

Additional aspects and/or advantages of the invention will be set forth in part in the description which follows and, in part, will be obvious from the description, or may be learned by practice of the invention.

In order to achieve the above aspects and/or other features of the present invention, there is provided an apparatus for warming up a light source lamp of an image input device, including a scanner module having the light source lamp, the scanner module turning on/off the light source lamp in accordance with a received control signal, an operation panel comprising a numeral key, a function key, and a display window, wherein the operation panel is used to input an on/off time or day of the light source lamp, a real time clock processing time data such as year, month, date, day, hour, minute, and second, a memory storing the on/off time or day of the light source lamp, and a control unit controlling the memory to store the on/off time or day input through the operation panel, and controlling the scanner module so that the light source lamp is turned on in response to supply of electricity. The control unit determines whether or not the on/off time or day of the light source lamp is preset, and upon determining a preset lamp-off time according to the time data input through the real time clock, the control unit controls the scanner module to turn on the light source lamp. The control unit also controls the scanner module so that in response to a key input signal being entered through the operation panel with the light source lamp being in an off state, or in response to the determination of a preset lamp-on time, the light source lamp is turned on.

According to the present invention, there is also provided a control method of an apparatus to warm up a light source lamp of an image input device, the method comprising turning on the light source lamp in response to a supply of electricity, determining whether a lamp-on/off time or day of the light source lamp is preset, converting to a power save mode, in response to there being no preset lamp-on/off time or day, after a predetermined time that there is not input of a key input signal through an operation panel, determining whether the preset lamp-on/off time or day is a lamp-off time, and accordingly turning off the light source lamp according to the preset time or day, determining whether the preset lamp-on/off time or day is a lamp-on time in response to the lamp being turned off, and accordingly turning on the light source lamp and converting to a warming up mode, and turning on the light source lamp and converting to the warming up mode in response to the key input signal occurring before the lamp-on time.

Accordingly, as the light source lamp on/off time is preset, the light source lamp is automatically turned off during the preset non-use time or day that the image input device is set to be in non-use, while also being automatically turned on and warmed up during the preset operating time or day. The light source lamp can also be turned on and warmed up by the manipulation of the keys of the operation panel.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a block diagram schematically showing a conventional multifunction machine;

FIG. 2 is a block diagram illustrating a warming up device of a light source lamp according to an embodiment of the present invention; and

FIG. 3 is a flowchart illustrating a control method of the warming up device of FIG. 2.

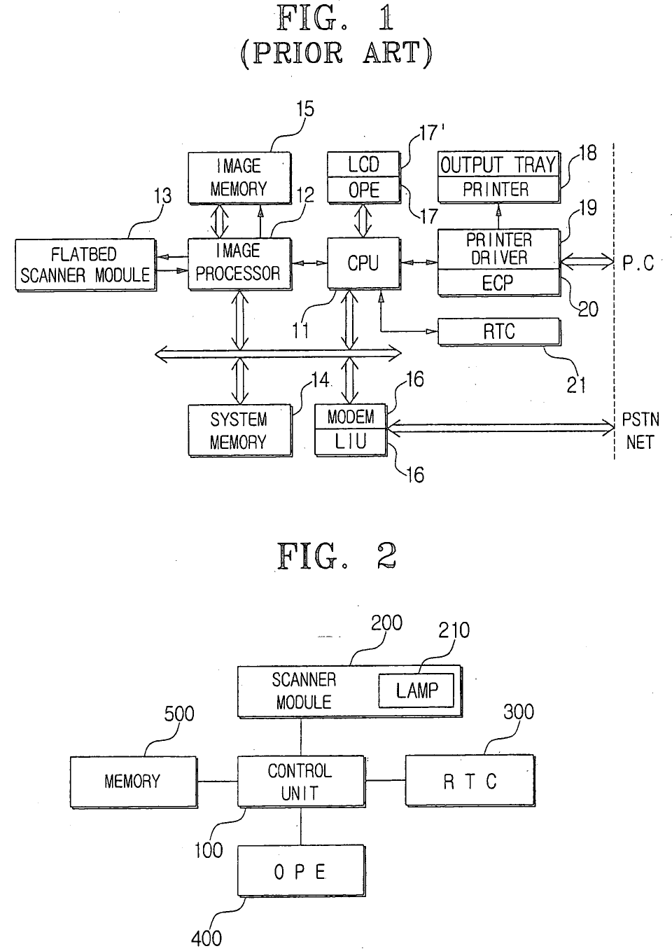

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

FIG. 2 is a block diagram schematically showing a warming up device of a light source lamp according to an embodiment of the present invention. As shown, the warming up device of the light source lamp includes a scanner module 200, an operation panel 400, a real time clock (RTC) 300, a memory 500, and a control unit 100.

The scanner module 200 is provided with a light source lamp 210 for reading in image data, and moves under a glass plate on which a document is placed to read the image data. The light source lamp 210 is turned on and off in accordance with a control signal.

The operation panel 400 is provided with numeral keys, function keys for function selection, and a display window configured as an LCD, enabling an operator to input various control commands, including a lamp-on/off command, and time or day.

The RTC 300 processes time data such as the year, month, date, day, hour, minute, and second, and outputs the processed data in a real-time basis. The memory 500 stores a system control program therein, and also stores the lamp-on/off time or day that was preset by the operator.

The control unit 100 controls the overall operation of the system, and also controls the memory 500 which is embedded with the program for driving the entire system. The control unit 100 is connected with the operation panel 400 through a serial communication for data exchange, enabling indication of key input and LCD-displayed data. The control unit 100 also controls the scanner module 200 to scan the image data. Further, the control unit 100 controls the light source lamp 210 to be turned on in accordance with the input of a key signal through the operation panel 400, and as the operator inputs a setting for a certain lamp-on/off time and a day, the control unit 100 also controls the scanner module 200 to turn on/off the light source lamp 210 in accordance with the preset lamp-on/off time and day. It is understood that the preset day could mean a day of the week, e.g. Saturday or Monday, as well as a calendar date.

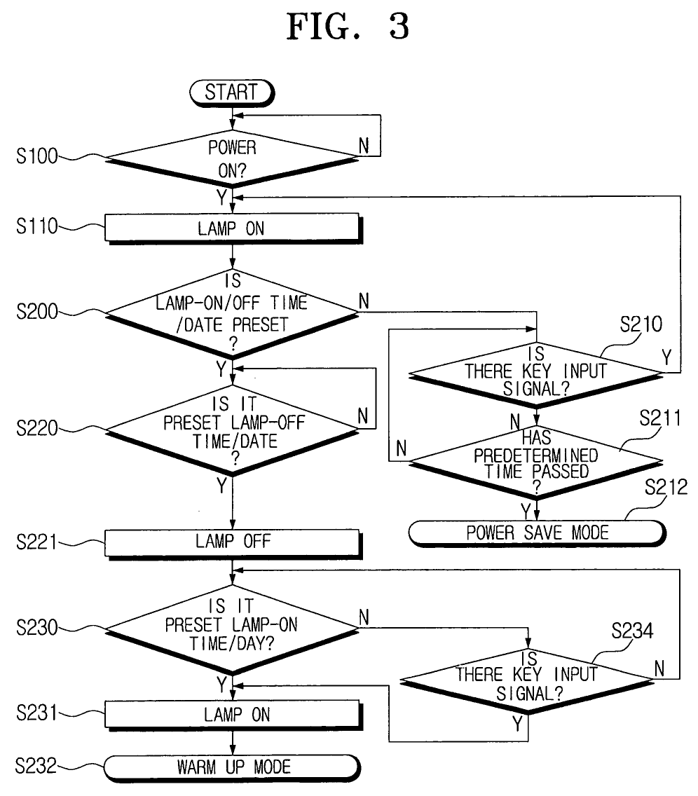

The control method of controlling the operation of the warming up device for a light source lamp of the image forming apparatus will be described in greater detail below with reference to FIG. 3.

First, as the system is turned on with the power supply to the multifunction machine including the image forming apparatus, the light source lamp 210 is turned on (S100, S110). Next, it is determined whether there is preset lamp-on/off time or day by the operator (S200), and, if not, it is determined whether there is a key input signal. If there is no key input signal, the standby mode or the operation mode is maintained. The system changes to power-save mode when there is no key input for a predetermined time, and, accordingly, the light source lamp 210 is turned off (S210, S211, S212).

When there is a preset lamp-on/off time or day, the light source lamp 210 is turned off when the time information input from the RTC 300 matches with the lamp-off time (S220, S221) stored in the memory.

If the operator sets a lamp-on time or day which occurs when the light source lamp 210 is off, the light source lamp 210 is turned on when the time information input from the RTC 300 matches with the lamp-on time stored in the memory 500, and the mode is switched to the warm up mode (S230, S231, S232).

If there is a key input signal from the operation panel 400 when the light source lamp 210 is off and before the predetermined lamp-on time, the light source lamp 210 is turned on, and the mode is switched to the warm up mode (S234).

The operator has an added convenience because, by presetting a predetermined time or day that he/she does not usually use the machine, such as lunchtime, the light source lamp 210 is turned off at the predetermined time or day, while he/she can also have the light source lamp 210 warmed up a good time before the actual operation of the machine. Furthermore, because the operator can input the lamp-on/off time and day through the operation panel 400, the lamp can be turned on/off in accordance with the key input signal through the operation panel 400. The present invention can be effectively applied to a stand-alone model.

According to the present invention, by turning off the light source lamp 210 of the image forming apparatus during a time when the operator does not use it, power consumption can be saved and the lifespan of the parts can be lengthened. Further, because the operator can have the light source lamp 210 warmed up a good time before the actual operation, the delay of actual operation due to the warming up time is reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to warm up a light source lamp of an image input device, comprising:
a scanner module having the light source lamp, the scanner module turning on/off the light source lamp in accordance with a received control signal;
an operation panel to input an on/off time or day of the light source lamp;
a real time clock processing time data comprising year, month, date, day, hour, minute, and second;
a memory storing the on/off time or day of the light source lamp; and
a control unit controlling the memory to store the on/off time or day input through the operation panel, and controlling the scanner module so that the light source lamp is turned on in response to the input of electricity,
wherein the control unit determines whether the on/off time or day of the light source lamp is preset, and upon determining a lamp-off time according to the time data input through the real time clock, controlling the scanner module to turn off the light source lamp, and controlling the scanner module so that in response to a key input signal being entered through the operation panel with the light source lamp being in an off state, or in response to the determination of a preset lamp-on time, the light source lamp is turned on.

2. A control method of an apparatus to warm up a light source lamp of an image input device, the method comprising:
turning on the light source lamp in response to a supply of electricity;
determining whether a lamp-on/off time or day of the light source lamp is preset;
converting to a power save mode, in response to there being no preset lamp-on/off time or day, after a predetermined time that there is not input of a key input signal through an operation panel;
determining whether the preset lamp-on/off time or day is a lamp-off time, and accordingly turning off the light source lamp according to the preset time or day;
determining whether the preset lamp-on/off time or day is a lamp-on time in response to the lamp being turned off; and accordingly turning on the light source lamp and converting to a warming up mode; and
turning on the light source lamp and converting to the warming up mode in response to the key input signal occurring before the lamp-on time.

3. An apparatus to warm up a light source lamp of an image input device, comprising:
a scanner unit having the light source lamp;
a memory unit storing a preset lamp-on/off time and/or day; and
a control unit controlling the scanner unit to turn the light source lamp on and off according to the preset lamp-on/off time and/or day;
wherein the control unit also controls the scanner unit to turn the light source lamp on and off according to an input signal from a user that is not preset.

4. The apparatus according to claim 3, wherein the light source lamp is turned on in response to power being supplied to the image input device.

5. The apparatus according to claim 4, wherein the control unit determines, upon power being supplied, whether there is a preset lamp-on/off time and/or day.

6. The apparatus according to claim 5, wherein the image input device enter a power save mode in response to there being no preset lamp-on/off time and/or day, and no input signal from a user within a predetermined time.

7. The apparatus according to claim 5, wherein the control unit determines whether the preset lamp-on/off time and/or day is a lamp-on or a lamp-off signal, and then controls the light source lamp according to the real time clock and the lamp-on or lamp-off signal.

8. The apparatus according to claim 7, wherein the light source lamp is turned on in response to the input signal from a user being received by the control unit while the light source lamp is turned off.

9. The apparatus according to claim 3, further comprising a real time clock, wherein the real time clock processes time data comprising year, month, day, date, hour, minute, and second, and outputs the processed data in a real-time basis.

10. The apparatus according to claim 3, wherein the memory also stores a system control program.

11. The apparatus according to claim 3, further comprising an operation panel, wherein the user inputs a lamp-on/off time and/or day, and other control commands, on the operation panel.

12. The apparatus according to claim 11, wherein the operation panel comprises:
numeral keys;
function keys; and
a display window;
wherein the user inputs the lamp-on/off time and/or day, and other control commands, using the numeral and function keys, the functions of which are displayed on the display window.

13. The apparatus according to claim 12, wherein the display window is an LCD.

14. The apparatus according to claim 11, wherein the operation panel is connected with the control unit through a serial communication member.

15. A method of controlling an apparatus to warm up a light source lamp of an image input device, the method comprising:
determining whether a lamp-on/off time and/or day is preset;
turning the light source lamp on and off according to the preset lamp-on/off time and/or day; and
turning the light source lamp on and off according to input signals from a user.

16. The method of claim 15, further comprising turning the light source lamp on in response to power being supplied to the image input device.

17. The method of claim 16, wherein the image input device goes into a power save mode in response to there being no preset lamp-on/off time and/or day and no input signals from a user within a predetermined time.

18. The method of claim 16, wherein the light source lamp is turned off in response to a preset lamp-off time and/or day occurring.

19. The method of claim 18, wherein the light source lamp is then turned back on in response to a present lamp-on time and/or day occurring, or in response to an input signal from a user.

20. An apparatus to warm up a light source lamp of an image input device, comprising:
a scanner unit having the light source lamp; and
a control unit turning the light source lamp on at a preset time and/or day;
wherein the light source lamp is warmed up at the preset time and/or day before an operation by a user, thereby reducing delay of the operation due to a warming up time.
